(19) United States
(12) Patent Application Publication
(10) Pub. No.: US 2014/0056489 A1
(43) Pub. Date: Feb. 27, 2014

(54) SYSTEM AND METHOD FOR SHARING MEDIA

(71) Applicant: Keith Shoji Kiyohara, Santa Monica, CA (US)

(72) Inventor: Keith Shoji Kiyohara, Santa Monica, CA (US)

(73) Assignee: Google Inc., Mountain View, CA (US)

(21) Appl. No.: 13/591,536

(22) Filed: Aug. 22, 2012

(51) Int. Cl. G06K 9/00

(52) U.S. Cl. 382/118

(57) ABSTRACT

A method, computer program product, and computer system for determining, on a computing device, a feature of an object associated with at least a portion of media. A value is associated with the feature of the object. A score of the object is determined based, at least in part, on the value associated with the feature. A determination is made whether to share an identity of the object based, at least in part, on the score of the object.

### TECHNICAL FIELD

This disclosure relates to media sharing systems and methods and, more particularly, to media tagging systems and methods.

### BACKGROUND

Media, such as pictures, may be generated by, e.g., digital cameras. When the pictures include people, they may be “tagged” to identify them in the pictures. For example, a picture may be taken of person A, person B, and person C. That picture may be uploaded, e.g., to a social media website, where person A may be tagged to identify person A in the picture for others to see. However, person A may not want to be tagged in every picture in which they appear. For instance, the picture may show person A in a non-flattering or unprofessional manner. If person A has already been tagged and does not wish to be tagged, person A must un-tag himself/herself to remove the link between person A and the picture. This may become cumbersome as there may be many pictures that include person A that already have either been tagged by, e.g., friends of person A or automatically tagged by facial recognition software. These pictures may need to be reviewed by person A to determine whether or not they want to be tagged. New pictures may subsequently be uploaded that person A may need to review and un-tag. In some cases, person A may be unaware that they have been tagged in a non-flattering or unprofessional picture and thus will not know to un-tag himself/herself.

### SUMMARY OF DISCLOSURE

In one implementation, a method for sharing media, performed by one or more computing devices, comprises determining, on a computing device, facial attributes of a person in a picture. A value is associated with each facial attribute of the person. A score of the person is determined based, at least in part, on the value of each facial attribute of the person. A determination is made whether a tag, which if applied to the picture would identify the person in the picture, is shared with one or more users based, at least in part, on the score of the person.

In one implementation, a method for sharing media, performed by one or more computing devices, comprises determining, on a computing device, a feature of an object associated with at least a portion of media. A value is associated with the feature of the object. A score of the object is determined based, at least in part, on the value associated with the feature. A determination is made whether to share an identity of the object based, at least in part, on the score of the object.

One or more of the following features may be included. Determining whether to share the identity of the object may include removing the identity of the object. Determining whether to share the identity of the object may include determining whether permission exists to tag the object with the identity. Determining whether to share the identity of the object may include determining whether to display a tag of the object with the identity to one or more users. Determining whether to share the identity of the object may include sorting the object relative to one or more other objects based, at least in part, on the score of the object. The feature of the object may include at least one of an emotion, a pose, a gesture, a location, and a background. The feature of the object may include at least one of smiling, crying, frowning, laughing, and one or more closed eyes.

In another implementation, a computer program product resides on a computer readable storage medium that has a plurality of instructions stored on it. When executed by a processor, the instructions cause the processor to perform operations comprising determining, on a computing device, a feature of an object associated with at least a portion of media. A value is associated with the feature of the object. A score of the object is determined based, at least in part, on the value associated with the feature. A determination is made whether to share an identity of the object based, at least in part, on the score of the object.

One or more of the following features may be included. Determining whether to share the identity of the object may include removing the identity of the object. Determining whether to share the identity of the object may include determining whether permission exists to tag the object with the identity. Determining whether to share the identity of the object may include determining whether to display a tag of the object with the identity to one or more users. Determining whether to share the identity of the object may include sorting the object relative to one or more other objects based, at least in part, on the score of the object. The feature of the object may include at least one of an emotion, a pose, a gesture, a location, and a background. The feature of the object may include at least one of smiling, crying, frowning, laughing, and one or more closed eyes.

In another implementation, a computing system includes a processor and memory configured to perform operations comprising determining, on a computing device, a feature of an object associated with at least a portion of media. A value is associated with the feature of the object. A score of the object is determined based, at least in part, on the value associated with the feature. A determination is made whether to share an identity of the object based, at least in part, on the score of the object.

One or more of the following features may be included. Determining whether to share the identity of the object may include removing the identity of the object. Determining whether to share the identity of the object may include determining whether permission exists to tag the object with the identity. Determining whether to share the identity of the object may include determining whether to display a tag of the object with the identity to one or more users. Determining whether to share the identity of the object may include sorting the object relative to one or more other objects based, at least in part, on the score of the object. The feature of the object may include at least one of an emotion, a pose, a gesture, a location, and a background. The feature of the object may include at least one of smiling, crying, frowning, laughing, and one or more closed eyes.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of an ID sharing process coupled to a distributed computing network according to an embodiment of the present disclosure;

FIG. 2 is a diagrammatic view of the client computer of FIG. 1 according to an embodiment of the present disclosure;

FIG. 3 is an illustrative flowchart of the ID sharing process of FIG. 1 according to an embodiment of the present disclosure;

FIG. 4 is an illustrative diagrammatic view of a screen image displayed by the ID sharing process of FIG. 1 according to an embodiment of the present disclosure; and

FIG. 5 is an illustrative diagrammatic view of a screen image displayed by the ID sharing process of FIG. 1 according to an embodiment of the present disclosure.

Like reference symbols in the various drawings indicate like elements.

### DETAILED DESCRIPTION OF THE EMBODIMENTS

According to some example embodiments consistent with the present disclosure, a media tagging application may be provided. The media may include, for example, videos, images (e.g., photographic content), audio, or combinations thereof. In some embodiments, one or more photos may be reviewed and scored to determine the appropriateness of tagging an individual in the photos. For example, after reviewing a photo it may be determined that the photo shows the individual in a non-flattering and/or non-professional manner (e.g., a photo in which the individual would likely choose not to be tagged). In some embodiments, the individual may be prevented from being tagged in that photo, or if the photo has already been tagged with the individual, the tag may be removed from the photo.

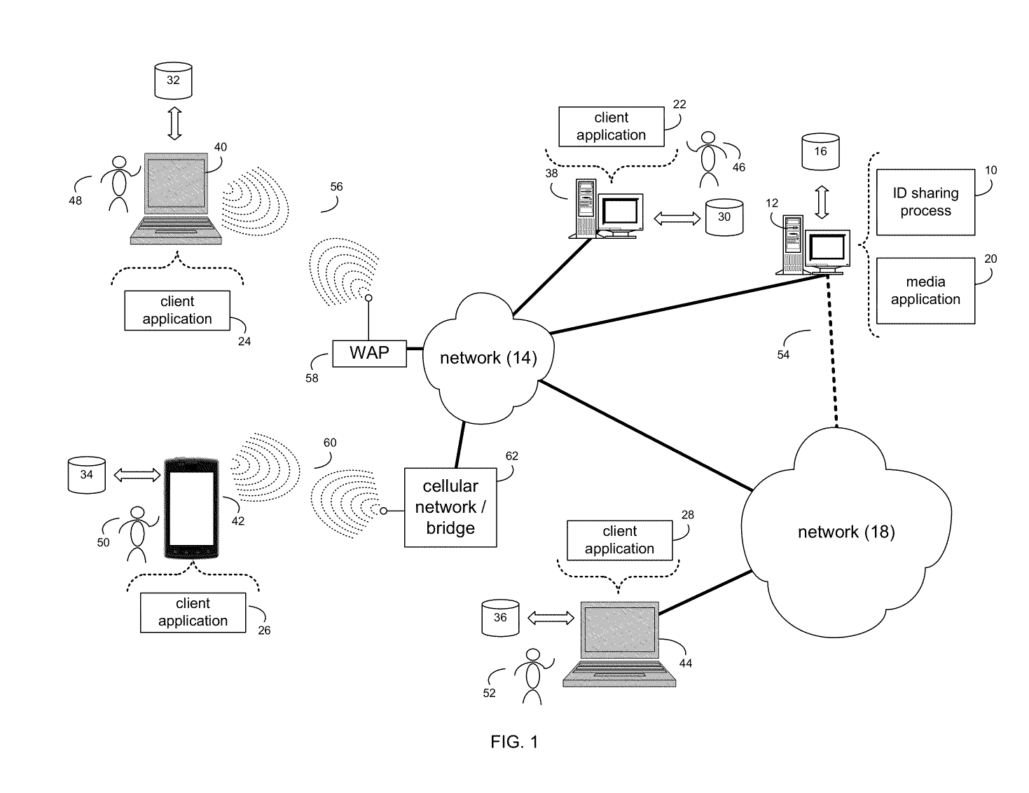

Referring to FIG. 1, there is shown ID sharing process 10 that may reside on and may be executed by a computer (e.g., client computer 12), which may be connected to a network (e.g., network 14) (e.g., the internet or a local area network). Examples of client computer 12 may include, but are not limited to, a personal computer(s), a laptop computer(s), mobile computing device(s), a server computer, a series of server computers, a mainframe computer(s), or a computing cloud(s). Client computer 12 may execute an operating system, for example, but not limited to Microsoft® Windows®; Mac® OS X®; Red Hat® Linux®, or a custom operating system, for example. (Microsoft and Windows are registered trademarks of Microsoft Corporation in the United States, other countries or both; Mac and OS X registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, ID sharing process 10 may determine, on a computing device, a feature of an object associated with at least a portion of media. A value may be associated with the feature of the object. A score of the object may be determined based, at least in part, on the value associated with the feature. A determination may be made whether to share an identity of the object based, at least in part, on the score of the object.

The instruction sets and subroutines of ID sharing process 10, which may be stored on storage device 16 coupled to client computer 12, may be executed by one or more processors (not shown) and one or more memory architectures (not shown) included within client computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Client computer 12 may execute a media application (e.g., media application 20), examples of which may include, but are not limited to, e.g., a facial recognition application, a website application (e.g., a social media website application), an electronic camera application, a media organization application, a tagging application, or other application that allows for the identification and/or “tagging” of media. ID sharing process 10 and/or media application 20 may be accessed via client applications 22, 24, 26, 28. ID sharing process 10 may be a stand alone application, or may be an applet/application/script that may interact with and/or be executed within media application 20. Examples of client applications 22, 24, 26, 28 may include but are not limited to a facial recognition application, a website application (e.g., a social media website application), an electronic camera application, a media organization application, a tagging application, or other application that allows for the identification and/or “tagging” of media, a standard and/or mobile web browser, an email client application, a textual and/or a graphical user interface, a customized web browser, or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, notebook computer 44, a tablet (not shown), a server (not shown), a data-enabled, cellular telephone (not shown), a television (not shown), a camera (not shown), and a dedicated network device (not shown).

One or more of client applications 22, 24, 26, 28 may be configured to effectuate some or all of the functionality of ID sharing process 10 (and vice versa). Accordingly, ID sharing process 10 may be a purely server-side application, a purely client-side application, or a hybrid server-side/client-side application that is cooperatively executed by one or more of client applications 22, 24, 26, 28 and ID sharing process 10.

One or more of client applications 22, 24, 26, 28 may be configured to effectuate some or all of the functionality of media application 20 (and vice versa). Accordingly, media application 20 may be a purely server-side application, a purely client-side application, or a hybrid server-side/client-side application that is cooperatively executed by one or more of client applications 22, 24, 26, 28 and media application 20.

Users 46, 48, 50, 52 may access client computer 12 and ID sharing process 10 directly through network 14 or through secondary network 18. Further, client computer 12 may be connected to network 14 through secondary network 18, as illustrated with phantom link line 54. ID sharing process 10 may include one or more user interfaces, such as browsers and textual or graphical user interfaces, through which users 46, 48, 50, 52 may access ID sharing process 10.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth™ device that is capable of establishing wireless communication channel 56 between laptop computer 40 and WAP 58. Smart phone 42 is shown wirelessly coupled to network 14 via wireless communication channel 60 established between smart phone 42 and cellular network/bridge 62, which is shown directly coupled to network 14. As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth™ is a telecommunications industry specification that allows, e.g., mobile phones, computers, smart phones, and other electronic devices to be interconnected using a short-range wireless connection.

Client electronic devices 38, 40, 42, 44 may each execute an operating system, examples of which may include but are not limited to Android™, Apple® iOS™, Mac® OS X®; Red Hat® Linux®, or a custom operating system.

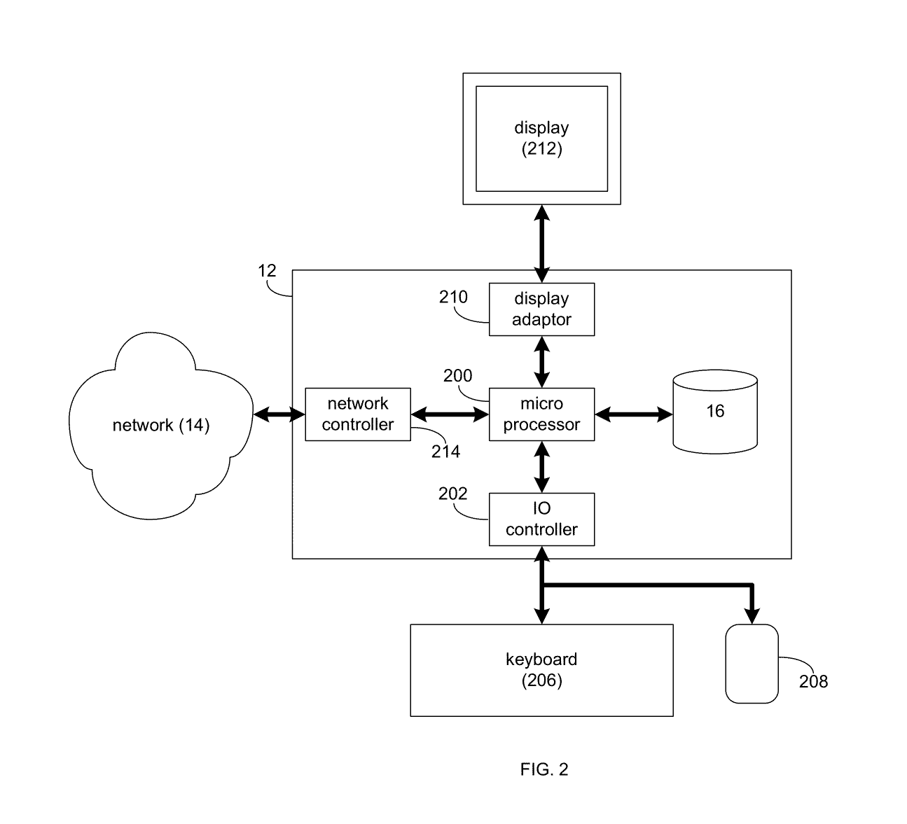

Referring also to FIG. 2, there is shown a diagrammatic view of client computer 12. While client computer 12 is shown in this figure, this is for illustrative purposes only and is not intended to be a limitation of this disclosure, as other configuration are possible. For example, any computing device capable of executing, in whole or in part, ID sharing process 10 may be substituted for client computer 12 within FIG. 2, examples of which may include but are not limited to client electronic devices 28, 30, 32, 34.

Client computer 12 may include a processor and/or microprocessor (e.g., microprocessor 200) configured to, e.g., process data and execute the above-noted code/instruction sets and subroutines of ID sharing process 10. Microprocessor 200 may be coupled via a storage adaptor (not shown) to the above-noted storage device 16. An I/O controller (e.g., I/O controller 202) may be configured to couple microprocessor 200 with various devices, such as keyboard 206, mouse 208, USB ports (not shown), and printer ports (not shown). A display adaptor (e.g., display adaptor 210) may be configured to couple display 212 (e.g., a CRT or LCD monitor) with microprocessor 200, while network controller/adaptor 214 (e.g., an Ethernet adaptor) may be configured to couple microprocessor 200 to the above-noted network 14 (e.g., the Internet or a local area network).

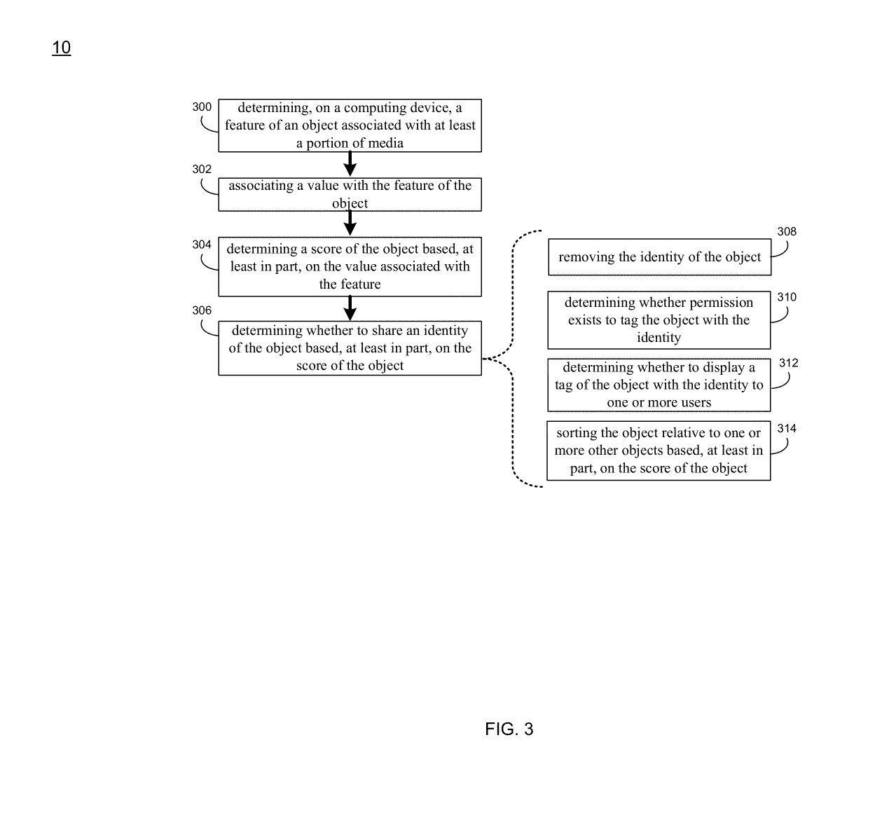

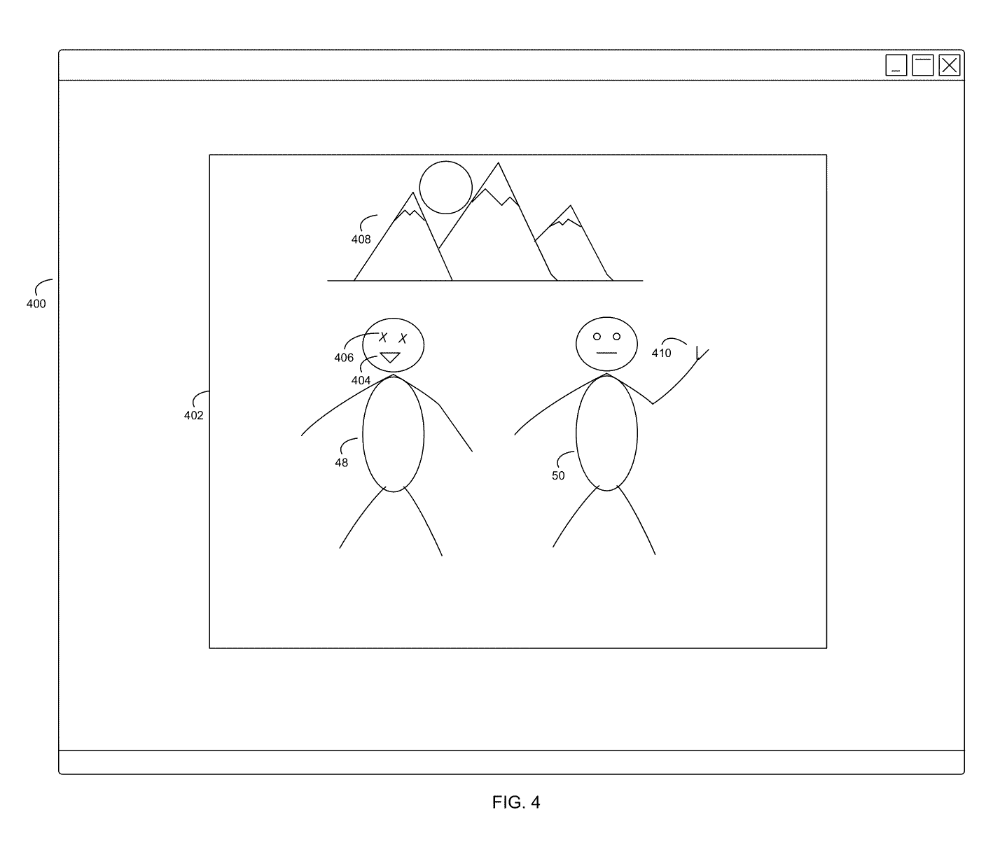

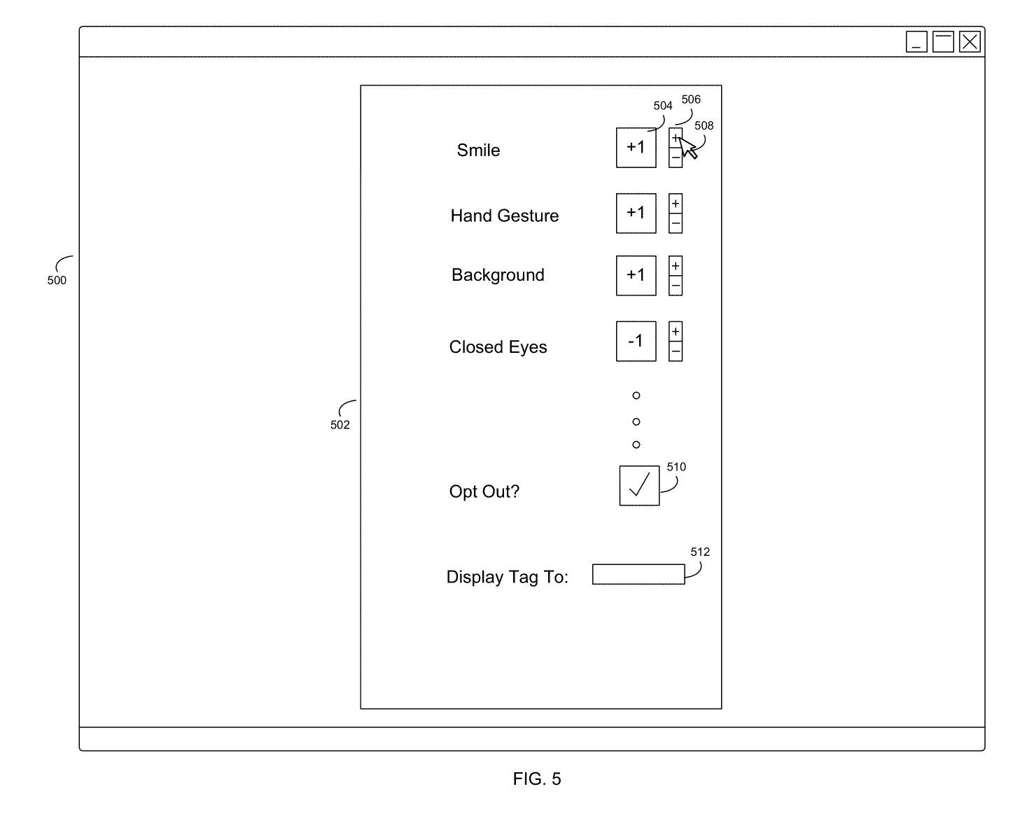

As discussed above and referring also to FIGS. 3-5, ID sharing process 10 may determine 300 a feature of an object associated with at least a portion of media (e.g., video, image, audio, etc.). ID sharing process 10 may associate 302 a value with the feature of the object. ID sharing process 10 may determine 304 a score of the object based, at least in part, on the value associated with the feature. ID sharing process 10 may determine 306 whether to share an identity of the object based, at least in part, on the score of the object.

As noted above, ID sharing process 10 may determine 300 a feature (e.g., an emotion, a pose, a gesture, a location, a background, the act of smiling, the act of crying, the act of frowning, the act of laughing, having one or more eyes partially or entirely closed, having a double-chin, etc.) of an object (e.g., users 48 and 50) associated with at least a portion of media, such as a picture image. For instance, assume for example purposes only that after uploading a picture (e.g., picture 402) to a social media website (e.g., via media application 20 and/or ID sharing process 10), ID sharing process 10 via client electronic device 42 may render in window 400 picture 402 that has been taken of users 48 and 50.

ID sharing process 10 may determine 300 that user 48 has the features of, e.g., smile 404 and both eyes closed 406. ID sharing process 10 may determine 300 the feature of emotion of user 48 is happy (e.g., as may be determined 300 by smile 404). ID sharing process 10 may determine 300 the feature of background of picture 402 as having mountains 408 or a sunset/sunrise. ID sharing process 10 may determine 300 that user 50 has a feature of a gesture (e.g., “peace” sign hand gesture 410).

Continuing with the above example, ID sharing process 10 may associate 302 a value with one or more of the above-noted features and may determine 304 a score of, e.g., user 48 based, at least in part, on the value associated with the one or more features. For example, ID sharing process 10 may associate 302 a default positive value (e.g., integer) of, e.g., +1 to smile 404. In the example, assume for illustrative purposes only that smile 404 is the only feature determined 300 by ID sharing process 10. As a result, ID sharing process 10 may determine 304 that user 48 has a score of +1.

Additionally/alternatively, assume now for illustrative purposes only that ID sharing process 10 also determines 300 that user 48 has both eyes closed. In the example, ID sharing process 10 may associate 302 a default negative value of, e.g., −1 to closed eyes 406. As a result, ID sharing process 10 may determine 304 that user 48 has a score of −1.

Additionally/alternatively, ID sharing process 10 may determine 304 a score of user 48 based, at least in part, on the combined value associated with each feature. For instance, continuing with the above example, ID sharing process 10 may determine 304 that user 48 has a combined score of 0 (i.e., the sum of the +1 smile 404 and the −1 closed eyes 406).

Additionally/alternatively, ID sharing process 10 may associate 302 a value with each of the above-noted features and may determine 304 a score of the entire picture 402 based, at least in part, on the value associated with each feature. For instance, continuing with the above example, ID sharing process 10 may associate 302 a positive value of, e.g., +1 to mountains 408 of the background and +1 to the “peace” sign hand gesture 410 of user 50. As such, ID sharing process 10 may determine 304 that user 48 has a combined score of +2 (i.e., the sum of the +1 smile 404, the −1 closed eyes 406, the +1 mountains 408, and the +1 “peace” sign hand gesture 410).

Additionally/alternatively, ID sharing process 10 may enable a user (e.g., user 48) to select the appropriate value for ID sharing process 10 to associate 302 with each feature. For example, within window 500, ID sharing process 10 may render a separate window and/or a pop-up window (e.g., pop-up window 502). Pop-up window 502 may include some of the above-noted example features such as a smile, hand gesture, background, closed eyes, etc, as well as other features. Pop-up window 502 may also include portion 504 that indicates the current value of each feature, as well as selectable portion 506 that may be used to adjust the associated 302 value. For example, ID sharing process 10 via pointer 508 may enable user 48 to select and adjust the appropriate score that ID sharing process 10 will associate 302 with the respective feature.

Based at least in part on the score, ID sharing process 10 may determine 306 whether to share the identity (e.g., tag) of user 48, e.g., with other users. For instance, ID sharing process 10 may determine 306 whether to tag user 48 in picture 402 and/or share that tag with other users. For example, ID sharing process 10 may determine 306 that any picture that includes user 48 and where user 48 has a determined 304 score above a threshold score of, e.g., 0 (e.g., a normal and/or flattering picture) may include a tag of user 48 that may be shared with other users. Conversely, ID sharing process 10 may determine 306 that any picture that includes user 48 and where user 48 has a determined 304 score below 0 (e.g., a non-flattering and/or unprofessional picture) may not include a tag of user 48 that may be shared with other users.

Additionally/alternatively, ID sharing process 10 may determine 306 that any picture that includes user 48 and where the picture as a whole has a determined 304 score above a threshold score may include a tag of user 48 that may be shared with other users. Conversely, ID sharing process 10 may determine 306 that any picture that includes user 48 and where the picture as a whole has a determined 304 score below a threshold score may not include a tag of user 48 that may be shared with other users.

Additionally/alternatively, ID sharing process 10 may determine 306 that any picture that includes user 48 and where a positive threshold feature is determined 300 to exist may automatically include a tag of user 48 that may be shared with other users, even if the determined 304 score is below the threshold score. For example, assume that the act of hugging is a positive threshold feature. Further assume that a picture includes user 48 hugging another user (or different users other than user 48 are hugging in the picture), but that other feature's values from the picture when combined are determined 304 by ID sharing process 10 as being below the threshold score. In this example, even though the score is below the threshold score, ID sharing process 10 may still include a tag of user 48 that may be shared with other users because the positive threshold feature of hugging has been determined 300 to exist.

Conversely, ID sharing process 10 may determine 306 that any picture that includes user 48 and where a negative threshold feature is determined 300 to exist may automatically exclude a tagging of user 48 from being shared with other users, even if the determined 304 score is above the threshold score. For example, assume that the act of smoking a cigarette is a negative threshold feature. Further assume that a picture includes user 48 (or another user in the picture) smoking a cigarette, but that other feature's values from the picture when combined are determined 304 by ID sharing process 10 as being above the threshold score. In this example, even though the score is above the threshold score, ID sharing process 10 may still exclude a tag of user 48 from being shared with other users because the negative threshold feature of smoking a cigarette has been determined 300 to exist.

Additionally/alternatively, the negative threshold feature may be the presence of another user (e.g., user 50) and/or a location where the picture was taken, which may be determined by, e.g., well known Global Positioning System (GPS) abilities that ID sharing process 10 may possess and/or that may be present in some client electronic devices, such as smart phones. The locations may also be added and/or edited manually. In the example, assume that being at any casino is a negative threshold feature. Further assume that a picture was taken of user 48 while at a casino, but that other feature's values from the picture when combined are determined 304 by ID sharing process 10 as being above the threshold score. In this example, even though the score is above the threshold score, ID sharing process 10 may still exclude a tag of user 48 from being shared with other users because the negative threshold feature of being at a casino (as indicated manually or via a GPS ability) has been determined 300 to exist.

In the above examples, if both a positive threshold feature and a negative threshold feature appear in the same picture, ID sharing process 10 may determine 306 that user 48 may be automatically excluded from sharing a tag with other users. Conversely, if both a positive threshold feature and a negative threshold feature appear in the same picture, ID sharing process 10 may determine 306 that a tag of user 48 may still be shared with other users.

Additionally/alternatively, if both a positive threshold feature and a negative threshold feature appear in the same picture, ID sharing process 10 may send a request (not shown) to user 48 to choose whether or not a tag of user 48 may be shared. The request may be sent via email, a pop-up message, an internal message within a social media site, or any other type of communication technique known to those skilled in the art.

ID sharing process 10 may remove 308 the tag of user 48. For example, assume for illustrative purposes only that a tag of user 48 in picture 402 has already been shared. In the example, ID sharing process 10 may perform one or more of the above-noted actions and determine 306 that the tag of user 48 (based on the associated score) should not be shared with other users. In the example, ID sharing process 10 may remove 308 the tag of user 48 from picture 402.

Additionally/alternatively, in the above example, ID sharing process 10 may send a request (not shown) to user 48 to choose whether or not the tag of user 48 may be removed and/or remain shared. The request may be sent via email, a pop-up message, an internal message within a social media site, or any other type of communication technique known to those skilled in the art.

ID sharing process 10 may determine 310 whether permission exists to tag user 48. For example, assume that the score of user 48 is above the above-noted threshold score. In the example, even though the score is above the threshold score, ID sharing process 10 may still exclude a tag of user 48 from being shared with other users because ID sharing process 10 may have determined 310 that user 48 has opted out of sharing tags in any pictures. User 48 may optionally opt out of being tagged in any pictures, e.g., via check portion 510 in pop-up window 502.

Additionally/alternatively, opting out may trigger ID sharing process 10 to send a request (not shown) to user 48 to choose whether or not user 48 would like to share a tag. The request may be sent via email, a pop-up message, an internal message within a social media site, or any other type of communication technique known to those skilled in the art.

Additionally/alternatively, ID sharing process 10 may determine 312 whether to display a tag of user 48 to one or more other users. For example, user 48 may decide that they want a tag of user 48 in picture 402 (e.g., for viewing in the personal profile (not shown) of user 48), but that user 48 does not want one or more other users to be able to see that tag. In the example, picture 402 may still be visible to one or more other users; however, ID sharing process 10 may prevent the tag of user 48 from being displayed to the one or more other users. User 48 may optionally select the specific users (or groups of users) that may have the tag displayed, e.g., via drop down menu 512 in pop-up window 502.

Additionally/alternatively, ID sharing process 10 may prevent the tag of user 48 from being displayed to the other users by removing picture 402 from being visible to the other users. User 48 may optionally select the specific users (or groups of users) that may have the tag displayed, e.g., via drop down menu 512 in pop-up window 502.

ID sharing process 10 may sort 314 user 48 relative to one or more other objects (e.g., user 50, mountains 408, etc.) based, at least in part, on the score. For example, assume for illustrative purposes only that ID sharing process 10 determines 304 that user 48 has a combined score of 0 (i.e., the sum of the +1 smile 404 and the −1 closed eyes 406), and that user 50 has a combined score of +1 (i.e., the +1 “peace” sign hand gesture 410). In the example, ID sharing process 10 may render a sorted 314 list (not shown) provided to, e.g., user 48, where user 48 is listed in descending order first (having a lower score of +0) and user 50 is listed second (having a higher score of +1) or listed in ascending order. The list may also be sent to user 48 using any of the above-noted communication techniques. The list may aid user 48 in determining whether or not to manually share a tag either of user 48 and 50, or whether to override the determined 306 tag sharing decision of ID sharing process 10.

While the above description may include ID sharing process 10 rendering picture 402 to perform one or more actions (e.g., determining 300 a feature of user 48 associated with picture 402), those skilled in will appreciate that ID sharing process 10 may analyze the raw data of picture 402 (e.g., without actually rendering picture 402) to determine 300 the features of user 48. As such, the description of performing one or more actions on a rendered picture should be taken as an example only and not to limit the scope of the disclosure.

While the scoring of each feature is disclosed in terms of integers +1 and −1, those skilled in the art will appreciate that other scoring techniques may also be used without departing from the scope of the disclosure. For example, the background mountains 408 may have a higher score (e.g., +5) than smile 404. As such, the description of scoring as +1 and −1 should be taken as an example only and not to otherwise limit the scope of the disclosure.

While the above description includes uploading picture 402 to a social media site, those skilled in the art will appreciate that one or more of the above-noted actions performed by ID sharing process 10 could also be done without requiring such an upload. For example, assume for illustrative purposes only that client electronic device 42 is, e.g., a camera (or a camera phone). As such, ID sharing process 10 may, e.g., determine 306 whether to share a tag of user 48 on the camera itself or elsewhere (i.e., before, during, and/or after picture 402 is uploaded to another computing device and/or the social media site, assuming picture 402 is ever uploaded to another computing device and/or the social media site). As such, the description ID sharing process 10 performing one or more of the above-noted actions on a picture that is uploaded to a social media site should be taken as an example only and not to otherwise limit the scope of the disclosure.

Those skilled in the art will appreciate that features other than those noted above may also be determined 300 by ID sharing process 10 without departing from the scope of the disclosure. As such, the features of smile 404, both eyes closed 406, background mountain 408, and hand gesture 410 should be taken as an example only and not to otherwise limit the scope of the disclosure. Furthermore, those skilled in the art will appreciate that while users 48 and/or 50 may be the objects with an associated 302 value, the objects may also include anything within picture 402 (e.g., mountains 408). As such, the description of the objects being users 48 and/or 50 (i.e., people) should be taken as an example only and not to otherwise limit the scope of the disclosure.

While the above description describes “tagging” user 48 in picture 402, those skilled in the art will appreciate that “tagging” may include various well known techniques that may identify user 48 in picture 402. As such, any particularly described tagging techniques or implementations of tagging should be taken as an example only and not to otherwise limit the scope of the disclosure.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various embodiments of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The embodiment(s) were chosen and described in order to best explain the principles of the disclosure and the practical application, and to enable others of ordinary skill in the art to understand the disclosure for various embodiment(s) with various modifications and/or any combinations of embodiment(s) as are suited to the particular use contemplated.

Having thus described the disclosure of the present application in detail and by reference to embodiment(s) thereof, it will be apparent that modifications, variations, and any combinations of embodiment(s) (including any modifications, variations, and combinations thereof) are possible without departing from the scope of the disclosure defined in the appended claims.

What is claimed is:

1. A computer-implemented method, comprising:
determining, on a computing device, one or more facial attributes of a person in a picture;
associating a value with each facial attribute of the person;
determining a score of the person based, at least in part, on the value of each facial attribute of the person; and
determining whether a tag, which if applied to the picture would identify the person in the picture, is shared with one or more users based, at least in part, on the score of the person.

2. A computer-implemented method, comprising:
determining, on a computing device, a feature of an object associated with at least a portion of media;
associating a value with the feature of the object;
determining a score of the object based, at least in part, on the value associated with the feature; and
determining whether to share an identity of the object based, at least in part, on the score of the object.

3. The computer-implemented method of claim 2 wherein determining whether to share the identity of the object includes removing the identity of the object.

4. The computer-implemented method of claim 2 wherein determining whether to share the identity of the object includes determining whether permission exists to tag the object with the identity.

5. The computer-implemented method of claim 2 wherein determining whether to share the identity of the object includes determining whether to display a tag of the object with the identity to one or more users.

6. The computer-implemented method of claim 2 wherein determining whether to share the identity of the object includes sorting the object relative to one or more other objects based, at least in part, on the score of the object.

7. The computer-implemented method of claim 2 wherein the feature of the object includes at least one of an emotion, a pose, a gesture, a location, and a background.

8. The computer-implemented method of claim 2 wherein the feature of the object includes at least one of smiling, crying, frowning, laughing, and one or more closed eyes.

9. A computer program product residing on a computer readable storage medium having a plurality of instructions stored thereon which, when executed by a processor, cause the processor to perform operations comprising:
determining, on a computing device, a feature of an object associated with at least a portion of media;
associating a value with the feature of the object;
determining a score of the object based, at least in part, on the value associated with the feature; and
determining whether to share an identity of the object based, at least in part, on the score of the object.

10. The computer program product of claim 9 wherein determining whether to share the identity of the object includes removing the identity of the object.

11. The computer program product of claim 9 wherein determining whether to share the identity of the object includes determining whether permission exists to tag the object with the identity.

12. The computer program product of claim 9 wherein determining whether to share the identity of the object includes determining whether to display a tag of the object with the identity to one or more users.

13. The computer program product of claim 9 wherein determining whether to share the identity of the object includes sorting the object relative to one or more other objects based, at least in part, on the score of the object.

14. The computer program product of claim 9 wherein the feature of the object includes at least one of an emotion, a pose, a gesture, a location, and a background.

15. The computer program product of claim 9 wherein the feature of the object includes at least one of smiling, crying, frowning, laughing, and one or more closed eyes.

16. A computing system including a processor and memory configured to perform operations comprising:
determining, on a computing device, a feature of an object associated with at least a portion of media;
associating a value with the feature of the object;
determining a score of the object based, at least in part, on the value associated with the feature; and
determining whether to share an identity of the object based, at least in part, on the score of the object.

17. The computing system of claim 16 wherein determining whether to share the identity of the object includes removing the identity of the object.

18. The computing system of claim 16 wherein determining whether to share the identity of the object includes determining whether permission exists to tag the object with the identity.

19. The computing system of claim 16 wherein determining whether to share the identity of the object includes determining whether to display a tag of the object with the identity to one or more users.

20. The computing system of claim 16 wherein determining whether to share the identity of the object includes sorting the object relative to one or more other objects based, at least in part, on the score of the object.

21. The computing system of claim 16 wherein the feature of the object includes at least one of an emotion, a pose, a gesture, a location, and a background.

22. The computing system of claim 16 wherein the feature of the object includes at least one of smiling, crying, frowning, laughing, and one or more closed eyes.
